(19) United States
(12) Patent Application Publication
(10) Pub. No.: US 2026/0011098 A1
(43) Pub. Date: Jan. 8, 2026

(54) ACCESSIBLE INDIVIDUAL AND GROUP INTERACTIONS IN A VIRTUAL ENVIRONMENT

(71) Applicant: Roblox Corporation, San Mateo, CA (US)

(72) Inventors: Mike FRIED, San Mateo, CA (US); Angelica QUACH, San Mateo, CA (US); Samuel BOUHADANA, San Mateo, CA (US); Luke WEBER, San Mateo, CA (US); Chase MCCARTY, San Mateo, CA (US)

(73) Assignee: Roblox Corporation, San Mateo, CA (US)

(21) Appl. No.: 19/249,823

(22) Filed: Jun. 25, 2025

Related U.S. Application Data
(60) Provisional application No. 63/668,583, filed on Jul. 8, 2024.

(51) Int. Cl. G06T 19/20

(52) U.S. Cl. CPC G06T 19/20; G06T 2219/2004; G06T 2219/2016

(57) ABSTRACT

Some implementations relate to methods, systems, and computer-readable media for providing accessible controls and contextual indications. Some implementations may include receiving control inputs from an input device, the control inputs comprising a selection of a portion of a user interface of the virtual experience, tracing of a path in the user interface, or a combination thereof, assembling a control queue based on the received control inputs; implementing the control queue by directing a virtual experience engine to perform control actions corresponding to the received control inputs in the control queue, rendering results of the implementation of the control queue by updating the user interface, and providing one or more contextual indicators of the results of the implementation of the control queue in the user interface.

### CROSS-REFERENCE TO RELATED APPLICATIONS

This application claims priority to U.S. Provisional Application No. 63/668,583, entitled “ACCESSIBLE INDIVIDUAL AND GROUP INTERACTIONS IN A VIRTUAL ENVIRONMENT,” filed on Jul. 8, 2024, the content of which is incorporated herein in its entirety.

### TECHNICAL FIELD

Implementations relate generally to online virtual experience platforms, and more particularly to methods, systems, and computer-readable media for accessible individual and group interactions in a virtual environment.

### BACKGROUND

Online platforms, such as virtual experience platforms and online gaming platforms, often provide virtual experiences that can be interacted with by a user. For example, a user may direct an avatar to traverse a virtual experience or portion thereof, place objects, hold objects, perform actions, and others. However, it can be difficult for some users to accurately control an avatar due to a design of a user interface, controller, or other input features. Furthermore, during group interaction between two or more avatars within a virtual experience, it may be difficult to ascertain another user's intent due to limitations in animation, graphics, and/or rendering.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

Aspects of this disclosure are directed to methods, systems, and computer-readable media to provide accessible individual and group interactions in a virtual environment.

According to one aspect, a computer-implemented method to provide accessible control in a virtual experience of a virtual environment is provided, the method comprising: receiving control inputs from an input device, the control inputs comprising a selection of a portion of a user interface of the virtual experience, tracing of a path in the user interface, or a combination thereof; assembling a control queue based on the received control inputs; implementing the control queue by directing a virtual experience engine to perform control actions corresponding to the received control inputs in the control queue; rendering results of the implementation of the control queue by updating the user interface; and providing one or more contextual indicators of the results of the implementation of the control queue in the user interface.

Various implementations of the computer-implemented method are described herein.

In some implementations, the received control inputs are provided by a user operating the input device via a cursor movement, a button press, a joystick movement, a cursor selection, a hardware user interface element input signal, or any combination thereof, wherein the operating the input device includes one or more actions performed using a single hand, a single finger, or a single appendage of the user.

In some implementations, two or more distinct control inputs are assembled in the control queue as a combined control input and the combined control input is implemented as a single input.

In some implementations, directing the virtual experience engine to implement the control queue comprises receiving user input from a user performed using a single hand, a single finger, or a single appendage of the user, wherein the input device is a hardware user interface element of a client device of the user.

In some implementations, the computer-implemented method further comprises detecting a control type of at least one of the received control inputs based on the assembled control queue; and providing the one or more contextual indicators based upon the control type and user preferences, wherein the contextual indicators comprise audio contextual indicators, visual contextual indicators, haptic contextual indicators, or any combination thereof.

In some implementations, the detected control type is one of a resize control type, a copy-paste control type, a deletion control type, or a repositioning control type.

In some implementations, the received control inputs, when implemented, resize a virtual object in the virtual experience and the received control inputs comprise a first control input selecting a corner of the virtual object and a second control input indicating a linear path corresponding to a new size of the virtual object, wherein the virtual object is resized based on the first control input and the second control input.

In some implementations, the computer-implemented method further comprises receiving a selection of a control element, wherein the selected control element is a copy-paste control element, a deletion control element, or a repositioning control element, wherein the virtual object is modified based on the selected control element.

In some implementations, when the selected control element is the copy-paste control element, the received control inputs further comprise a first control input selecting a virtual object in the virtual experience to be copied and pasted, a second control input indicating a location in the virtual experience for the virtual object to be copied to, and a final control input signaling the virtual experience to copy and paste the virtual object, wherein the virtual object is copied and pasted based on the first control input and the second control input.

In some implementations, when the selected control element is the deletion control element, the received control inputs further comprise a first control input selecting a virtual object in the virtual experience to be deleted, and a final control input signaling the virtual experience to delete the virtual object, wherein the virtual object is deleted based on the first control input.

In some implementations, when the selected control element is the repositioning control element, the received control inputs further comprise a first control input selecting a virtual object to be repositioned in the virtual experience, a second control input indicating a linear path of motion for the virtual object, and a final control input signaling the virtual experience to reposition the virtual object based on the first control input and the second control input, wherein the virtual object is repositioned based on the first control input and the second control input.

According to another aspect, a non-transitory computer-readable medium is provided. The non-transitory computer-readable medium with instructions stored thereon that, responsive to execution by a processing device, causes the processing device to perform operations comprising: receiving control inputs from an input device, the control inputs comprising a selection of a portion of a user interface of a virtual experience of a virtual environment, tracing of a path in the user interface, or a combination thereof; assembling a control queue based on the received control inputs; implementing the control queue by directing a virtual experience engine to perform control actions corresponding to the received control inputs in the control queue; rendering results of the implementation of the control queue by updating the user interface; and providing one or more contextual indicators of the results of the implementation of the control queue in the user interface.

Various implementations of the non-transitory computer-readable medium are described herein.

In some implementations, two or more distinct control inputs are assembled in the control queue as a combined control input and the combined control input is implemented as a single input.

In some implementations, the operations further comprise detecting a control type of at least one of the received control inputs based on the assembled control queue; and providing the one or more contextual indicators based upon the control type and user preferences, wherein the contextual indicators comprise audio contextual indicators, visual contextual indicators, haptic contextual indicators, or any combination thereof.

In some implementations, the received control inputs, when implemented, resize a virtual object in the virtual experience and the received control inputs comprise a first control input selecting a corner of the virtual object and a second control input indicating a linear path corresponding to a new size of the virtual object, wherein the virtual object is resized based on the first control input and the second control input.

In some implementations, the operations further comprise receiving a selection of a control element, wherein the selected control element is a copy-paste control element, a deletion control element, or a repositioning control element.

According to another aspect, a system is disclosed, comprising: a memory with instructions stored thereon; and a processing device, coupled to the memory, the processing device configured to access the memory, wherein the instructions when executed by the processing device cause the processing device to perform operations comprising: receiving control inputs from an input device, the control inputs comprising a selection of a portion of a user interface of a virtual experience of a virtual environment, tracing of a path in the user interface, or a combination thereof; assembling a control queue based on the received control inputs; implementing the control queue by directing a virtual experience engine to perform control actions corresponding to the received control inputs in the control queue; rendering results of the implementation of the control queue by updating the user interface; and providing one or more contextual indicators of the results of the implementation of the control queue in the user interface.

Various implementations of the system are described herein.

In some implementations, two or more distinct control inputs are assembled in the control queue as a combined control input and the combined control input is implemented as a single input.

In some implementations, the operations further comprise detecting a control type of at least one of the received control inputs based on the assembled control queue; and providing the one or more contextual indicators based upon the control type and user preferences, wherein the contextual indicators comprise audio contextual indicators, visual contextual indicators, haptic contextual indicators, or any combination thereof.

In some implementations, the operations further comprise receiving a selection of a control element, wherein the selected control element is a copy-paste control element, a deletion control element, or a repositioning control element.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIG. 2 is a schematic of a user interface with accessible controls for a virtual environment, in accordance with some implementations.

FIG. 3A is a schematic of an additional user interface with accessible controls for a virtual environment, in accordance with some implementations.

FIG. 3B is a schematic of an alternative user interface, in accordance with some implementations

FIG. 4 is a schematic of an additional user interface with accessible controls for a virtual environment, in accordance with some implementations.

FIG. 5 is a schematic of an additional user interface with accessible controls for a virtual environment, in accordance with some implementations.

FIG. 6 is a flowchart of an example method of accessible control over a virtual environment, in accordance with some implementations.

FIG. 7 is a flowchart of an example method of contextual indication, in accordance with some implementations.

FIG. 8 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

In some aspects, systems and methods are provided for accessible controls for a virtual environment. Online platforms, such as online virtual experience platforms, generally provide an ability to create, store, and distribute virtual experiences.

For example, virtual experience platforms may include user-generated content or developer-generated content (each referred to as “UGC” herein). The UGC may be stored and implemented through the virtual experience platform, for example, by allowing users to search and interact with various virtual experiences and associated virtual items. Virtual experiences may be presented in a search interface, whereby users may peruse different virtual experiences prior to entering a particular virtual experience.

Search interfaces and other interfaces also allow users to interact with virtual items, for example, for purchase, for trying on (e.g., fitting virtual clothing onto an avatar), for evaluating (e.g., temporarily granted access to use a virtual item in gameplay), and/or for other types of interactions. The search interfaces and other interfaces may also allow users to search for particular virtual items and/or particular virtual experiences for interacting with.

While search interfaces allow users to search for particular virtual experiences, virtual experiences themselves provide an immersive experience for a user. For example, avatars may move about virtual experiences and interact with a plurality of virtual items in a typical virtual experience. When creating virtual experiences, one or more users may work together or independently to create, choose, manipulate, and/or alter the virtual experience and virtual items within the virtual experience.

For example, a virtual experience may be built to have one or more virtual environments or be connected to a virtual environment. The virtual experiences can include 3D features, items, objects, and other 3D features. The included 3D features may be created by one or more users using a user interface with 3D controls.

Some 3D controls can include, for example, a joystick, a controller, a d-pad, a keyboard, a mouse, touchscreen, and others. These and other 3D controls may allow a user to direct an avatar to move about the user interface, interacting with, placing, moving, resizing, and otherwise manipulating the 3D features. For example, a user can place an object in a virtual environment, resize the object, move towards the object to place another object (e.g., on top or adjacent or proximate), and so on. Other variations may be applicable that are dependent upon specific implementations. Furthermore, as virtual environments and the 3D features therein are user-customizable, many other variations exist.

Alternative 3D controls may specify that a user is to use both hands, to use one or more fingers from each hand, and to view the user interface, and provide control inputs. Accordingly, some users may find alternative 3D controls to be cumbersome and/or complex. Furthermore, some users may find alternative 3D controls lack social context and/or the ability to allow users to interact with a virtual experience in a manner that allows others to intuitively understand another user's intent. In these scenarios, user enjoyment of creating in a 3D environment may be low.

Additionally, in some circumstances, if multiple users are creating a 3D environment together or otherwise interacting with a 3D environment, the context of activities for the other user may be difficult to detect. For example, an avatar moving towards an object and picking up the object may be related to movement of the object, deletion of the object, resizing of the object, and others. Accordingly, absent additional context, the intent of the motion towards an object may be difficult to glean from an observer's perspective.

Example implementations may provide accessible controls for a virtual environment that overcome, mitigate, or reduce these and other drawbacks. For example, accessible controls as described herein may allow for accessible control over an avatar with either one or two hands. Furthermore, user interface elements, displays, and sounds may be combined with the accessible controls (or used independently) to allow context of an avatar's intent to be more easily understood.

According to implementations described herein in detail, an online virtual experience platform may deploy a virtual experience user interface (VE UX) component at a server and provide one or more accessible controls and one or more contextual indicators within the virtual experience. The VE UX component, when interacted with by a user, may facilitate creation of virtual experiences, interactions between two or more avatars, and other benefits that improve user enjoyment of the virtual experience platform. Such accessible controls may improve accessibility for users with limited use of one or both hands.

Furthermore, such contextual indicators may improve accessibility for users with vision and/or hearing impairments, or users whose use context (e.g., hands unavailable for use, limited ability to view a screen, device with no audio output capability or speakers muted, etc.). Through improvement of accessibility, example implementations may provide technical benefits that include improved accessibility for users with disabilities (or otherwise with limited ability to use/access specific input or output modalities), reduced fatigue for users utilizing the user interface, and others. These and other features, benefits, and improvements will become apparent in this disclosure.

Hereinafter, further details surrounding example implementations and various aspects of this disclosure are described with reference to the figures.

### System Architecture

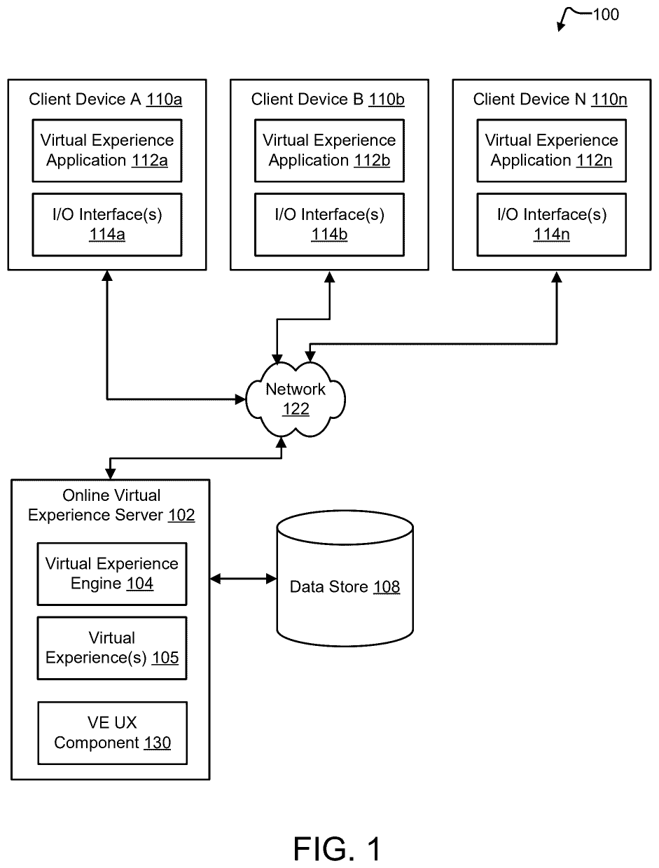

FIG. 1 illustrates an example network environment 100, in accordance with some implementations of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, and a client device 110 (or multiple client devices), all coupled via a network 122.

The online virtual experience server 102 can include, among other things, a virtual experience engine 104, one or more virtual experiences 105, and VE UX component 130. The online virtual experience server 102 may be configured to provide virtual experiences 105 to one or more client devices 110, and to provide accessible 3D controls and contextual indicators via the VE UX component 130, in some implementations.

Data store 108 is shown coupled to online virtual experience server 102 but in some implementations, can also be provided as part of the online virtual experience server 102. The data store may, in some implementations, be configured to store user data, control data, spatial telemetry data, and/or other contextual data in association with the VE UX component 130.

The client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some implementations, the client devices 110 may be configured to execute and display virtual experiences, which may include accessible controls as described herein.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer-readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, virtual server, etc.). In some implementations, a server may be included in the online virtual experience server 102, be an independent system, or be part of another system or platform. In some implementations, the online virtual experience server 102 may be a single server, or any combination of a plurality of servers, load balancers, network devices, and other components. The online virtual experience server 102 may also be implemented on physical servers, but may utilize virtualization technology, in some implementations. Other variations of the online virtual experience server 102 are also applicable.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., a user via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some implementations, online virtual experience server 102 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual reality (VR) games, or augmented reality (AR) games, for example. In some implementations, virtual experience creators and/or developers may search for virtual experiences, combine portions of virtual experiences, tailor virtual experiences for particular activities (e.g., group virtual experiences), and other features provided through the virtual experience server 102.

In some implementations, online virtual experience server 102 or client device 110 may include the virtual experience engine 104 or virtual experience application 112. In some implementations, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features (e.g., multiplayer capabilities, discerning user intent, and others). The components of the virtual experience engine 104 may generate commands that help compute and render the virtual experience (e.g., rendering commands, collision commands, physics commands, etc.).

In concert with the generated commands to render a virtual experience, additional commands related to accessible controls may also be provided. For example, commands that enable single hand control, dual hand control, and other types of control may be provided. These commands may allow a user to “trace” a path of motion using a single mouse pointer, joystick, or other input device, and the path may be implemented by the virtual experience engine 104 as though the user were controlling an avatar with alternative control inputs.

Similarly, other complex controls may also be recreated using a single input device such that a user may only involve use of one finger, hand, or appendage, rather than manipulating multiple control devices at once. For example, a user may select highlighted portions of an object and trace a ray by depressing a button and moving a controller, joystick, or mouse pointer in a direction of motion (e.g., left, right, forward, backwards, and so on), or a ray in a direction of resizing (e.g., up, down), and cause the execution of an associated command (e.g., resize object or move object) by selecting a button or releasing a button. Additional commands such as object deletion, object copying-pasting, and others, may be executed using a combination of button presses, key clicks, or joystick motions that occur in serial or in combination, such that alternative parallel controls (e.g., multiple button presses or joystick manipulation with two or more hands) are recreated with serial execution that allow one (e.g., a single) hand, finger, or appendage to be used instead.

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some implementations, each virtual experience 105 may have a different ratio between the virtual experience engine functions that are performed on the online virtual experience server 102 and the virtual experience engine functions that are performed on the client device 110.

In some implementations, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, virtual reality (VR) consoles, apparatuses, and/or headsets, etc. In some implementations, a client device 110 may also be referred to as a “user device.” In some implementations, one or more client devices 110 may connect to the online virtual experience server 102 at any given moment. It may be noted that the number of client devices 110 is provided as illustration, rather than limitation. In some implementations, any number of client devices 110 may be used.

In some implementations, each client device 110 may include an instance of the virtual experience application 112. The virtual experience application 112 may be rendered for interaction at the client device 110. During user interaction within a virtual experience interface provided by the virtual experience application 112, and in association with the VE UX component 130, a user's avatar may build, create, and otherwise implement a virtual environment. For example, a user may control the avatar to build walls, doors, windows, and place objects, items, and activities, within the virtual environment.

The user may direct the avatar using accessible controls such that complex operations can be performed with one hand, finger, or appendage, in lieu of two-handed control over a device. The user may also receive contextual indications provided by the virtual experience user interface (VE UX) component 130 that provide indications of a type of activity the avatar is performing. For example, a sound may be played back to represent object resizing (e.g., a crescendo of notes or increasing volume of a sound for an increase in size or a diminuendo of notes or decreasing volume of a sound for a decrease in size), object deletion (e.g., a crushing paper sound or explosion), object copy-paste (e.g., two notes in succession of the same type or a repetitive sound), object repositioning (e.g., a scraping sound), and others.

In some implementations, the VE UX component 130 may provide control and provisioning of virtual environments, virtual objects, and other virtual features within virtual experiences created on the online virtual experience platform 100. For example, environments, walls, boundaries, windows, roads, items, games, and others can be created and stored as new virtual experiences 105 for providing by the virtual experience platform 100, all using accessible controls and contextual indicators as described herein.

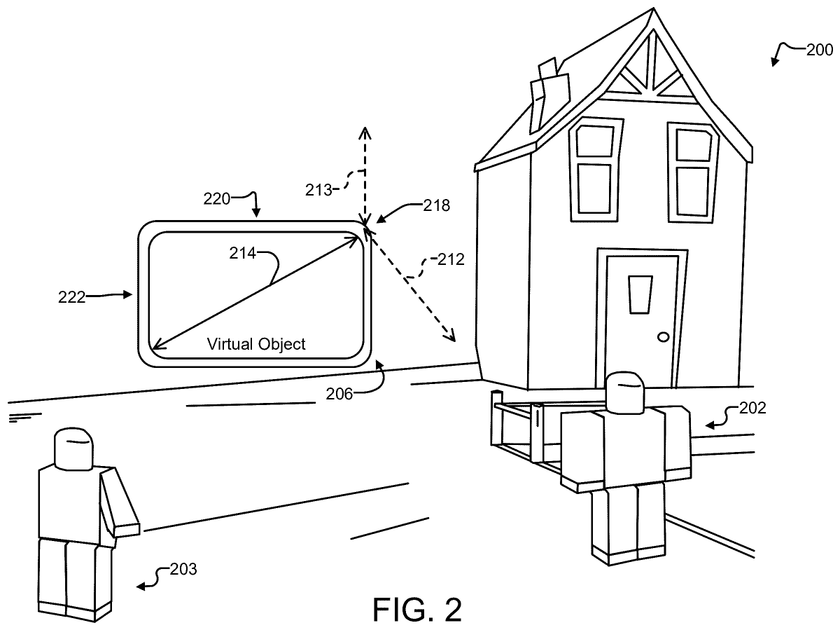

Hereinafter, example schematics of accessible controls provided by a virtual experience user interface, are described with reference to FIGS. 2-7.

### Object Resizing

FIG. 2 is a schematic of a user interface 200 with accessible controls for a virtual environment, in accordance with some implementations. As illustrated, the user interface 200 may include a rendered 2D view of a 3D virtual environment. Such a rendered 2D view of the 3D virtual environment may be presented in 2D by a display unit such as a monitor, a laptop screen, a television (TV), a head-mounted display, a heads-up display, a virtual reality (VR) headset, a mobile display, etc. The display unit may use one or more of a variety of display technologies, such as light-emitting diode (LED), cathode-ray tube (CRT), liquid-crystal display (LCD), thin-film transistor (TFT), organic light-emitting diode (OLED), quantum dot display (QLED), etc.

The rendered 2D view may be a 3D view if viewed through 3D goggles or another 3D viewing interface, in some implementations. Such a 3D view may be provided by using a stereoscopic approach, in which slightly different images are provided to each eye of a user. The disparity in images is interpreted by a user's brain as a 3D aspect.

The user interface 200 may allow for the control and provisioning of virtual environments, virtual objects, and other virtual features within virtual experiences. For example, the user interface 200 may be used by a user associated with first avatar 202 and/or a user associated with a second avatar 203. The users associated with the avatars in FIG. 2 may interact as a group within the user interface 200, to create a virtual experience 105.

In the example of FIG. 2, the user interface 200 includes several virtual objects rendered therein, such as a house, a door, a ground, and a virtual object 206. The virtual object 206 has been greatly simplified in FIG. 2 for clarity of discussion and can be representative of any virtual object 206 that may be created or manipulated with the virtual experience platform 100. For example, virtual objects such as trees, walls, fences, cars, and other virtual objects, may be created and/or manipulated as described herein.

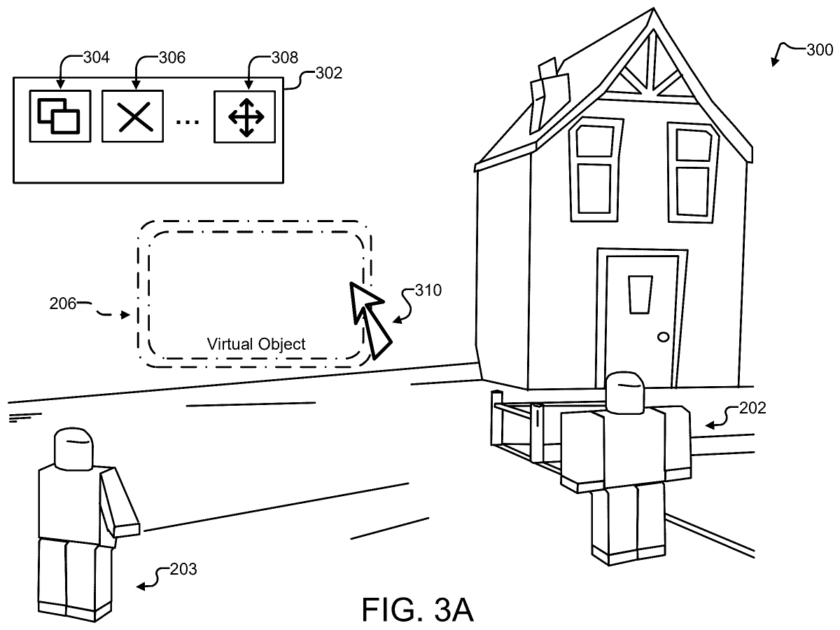

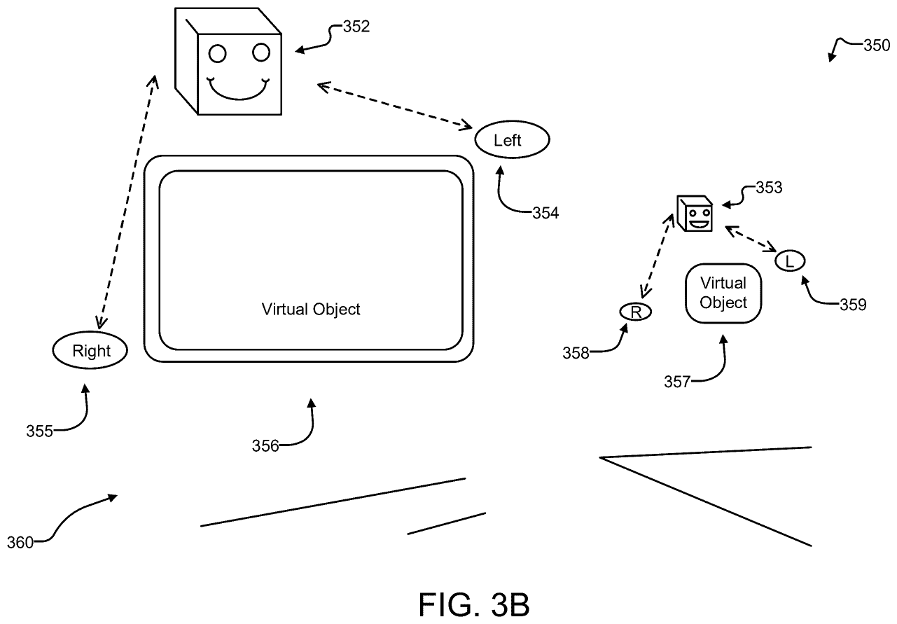

A user associated with the first avatar 202 may intend to resize the virtual object 206 from a first size to a second size, as shown by the expanding arrow 214. In this example implementation, an accessible control scheme is provided such that the user associated with the first avatar 202 first selects a corner 218 of the virtual object 206 by resting or positioning a cursor or other indicator proximate to the corner 218. The cursor is not illustrated in FIG. 2 for ease of visibility of additional arrows 212 and 213 (indicating the Y and Z directions, respectively). However, an appropriate example of such a cursor is illustrated as an arrow in FIG. 3A (e.g., cursor 310).

It is noted that in some implementations, a cursor 310 is only displayed for selection, while a different type of indicator is displayed for motion. In some implementations, the cursor 310 may be arranged differently, may comprise a different shape (e.g., a ray or line rather than an arrow, the cursor 310 may comprise a dotted line or circle rather than solid lines or arrows, the cursor 310 may comprise a highlighted portion of a viewport rather than a drawn object/cursor, and others). Other variations to the cursor 310 are also applicable.

Turning back to FIG. 2, upon selection of the corner 218, the user may move the same control input (e.g., a mouse, thumbpad, joystick, or others) in a single line or linear path to control the increase or decrease in size of the virtual object 206. For example, the user may drag the control input along line 212 (e.g., towards or away from the virtual object 206) to increase or decrease a size of the virtual object 206.

For example, the user may drag the control input along line 213 (e.g., upwards or downwards with respect to the object 206) to increase or decrease the size of the virtual object 206. It is noted that expanding arrow 214 represents a fixed scaling when resizing the virtual object 206, such that an appropriate (e.g., original) ratio of height and width of the virtual object 206 is retained. However, through separate selection of a horizontal surface 220 of the virtual object 206, or a vertical surface 222 of the virtual object 206, the user may also adjust (e.g., increase and/or decrease) horizontal or vertical sizes of the virtual object 206 independently and individually.

In addition to resizing the virtual object 206, other control inputs may be used to perform other operations on the virtual object 206, such as to control a position of the virtual object 206, perform deletion of at least one virtual object 206, repetition of at least one virtual object 206 (e.g., copying-pasting), and perform other operations. Moreover, given that the control inputs described above only involve inputs providing for the selection of an edge or corner, and movement in a linear direction, a control device may only use a joystick or another device that tracks linear motion and a button to effectuate the resizing.

Accordingly, a user may utilize one hand, finger, or appendage to move a joystick or another device that tracks linear motion to resize the virtual object 206. Similarly, if using a mouse (in addition to or instead of a joystick and button), only control input from one hand of the user is necessary to select a point and drag along a linear path with respect to the control scheme illustrated. Furthermore, if using a spatial or gyroscopic control device, a single control device for one hand of the user can be used such that the user may select and drag as discussed using the single device, such as to resize the virtual object 206. In these and other implementations, a user with limited mobility or limited use of appendages (e.g., having an amputated hand) may still be able to interact with and create virtual environments for virtual experiences.

While a user associated with the second avatar 203 may not initially understand the actions executed based on the control inputs provided by a user associated with the first avatar 202, a contextual indication of the size increase or decrease of the virtual object 206 may be provided. Such a contextual indication provides sensory feedback that clarifies the nature of a transformation applied to the virtual object 206.

In this example, the contextual indication of resizing may include an animation of the resizing of the virtual object 206 and/or the playback of a crescendo sound that grows louder for a size increase, a diminuendo sound that becomes softer for a size decrease, or another sound. Characteristics of the sound such as pitch may also provide a contextual indicator of how the size of the virtual object 206 changes. In some implementations, indications may include a virtual representation of an input device performing an action.

In this example, if a first user resizes virtual object 206, the user associated with second avatar 203 (and other proximate avatars within view of the virtual object 206 in the virtual experience) may be presented with a rendering of a virtual controller performing the resizing in the virtual experience. Other indications may also be provided, as appropriate.

### Object Deletion

FIG. 3A is a schematic of a user interface 300 with accessible controls for a virtual environment, in accordance with some implementations. As illustrated, the user interface 300 may include a rendered 2D view of a 3D virtual environment. Aspects of a 2D view are discussed further with respect to FIG. 2. The rendered 2D view may be a 3D view if viewed through 3D goggles or another 3D viewing interface, in some implementations. Aspects of a 3D view are discussed further with respect to FIG. 2.

It is noted that controls may also be implemented by movements, motions, and/or gestures performed by a user. Accordingly, while the rendered user interface as shown in FIG. 3A includes control elements rendered therein, some implementations may not include renderings of control inputs and instead rely partially or entirely on gesture or motion inputs.

Such gesture or motion inputs may be obtained from analyzing data from cameras and sensors. The cameras may be red-green-blue (RGB) cameras, depth-sensing cameras, a combination of both types of cameras, or other cameras (e.g., infrared camera, thermal camera, etc.). The sensors may include inertial measurement units (IMUs), electromyography (EMG) sensors, infrared sensors, radar sensors, and/or wearable sensors (e.g., data gloves). Such data may be preprocessed, subjected to feature extraction and machine learning (ML) models, and compared to a gesture library. This may be followed by corresponding gesture interpretation and computer execution of the interpreted gestures. Furthermore, some implementations may include both control renderings and motion input.

A control interface 302 may be rendered based upon a viewport provided to the user of the first avatar 202. For example, the control interface 302 may be rendered to apparently “float” about a fixed reference within the viewport, such as a plane within the viewport. In this example, another control interface may be rendered for view by the user of the second avatar 203 (not illustrated for clarity). The user of the first avatar 202 may select one or more of individual control elements 304, 306, and 308 from the control interface 302 for implementing different control sequences.

For example, control element 304 may be a copy-paste control element. Such a control element allows a user to select a virtual object and place a copy of the virtual object elsewhere in the virtual experience. For example, control element 306 may be a deletion element. Such a control element allows a user to select a virtual object and remove the selected virtual object from the virtual experience. For example, control element 308 may be a repositioning element. Such a control element allows a user to select a virtual object and move the selected virtual object to another location. In various implementations, fewer or more control elements may be provided, associated with different actions. Control elements 304, 306, and 308 are only example control elements and other possible control elements exist, such as a cut-and-paste control element, a rotation control element, and/or a shear control element.

Upon selection of an appropriate control element and/or virtual object, the user may trigger the implementation of the control type represented by the control element by issuing a signal to implement the relevant control type. For example, in user interface 300, the user may select the delete element 306, subsequently select the virtual object 206, and finally signal to execute the selected action (a delete action). In response to the signal to execute the delete action, the virtual object 206 is deleted (represented in FIG. 3A by dashed lines).

It is noted that while the control interface 302 is simplified and illustrates a particular number of control types, the same may vary in many ways. For example, an “undo” control element may be rendered and selected to undo the last control action or sequence of control actions, a repeat control element may be rendered and selected to repeat the last control action or sequence of control actions. Similarly, other elements that represent other control actions may be rendered and selected to implement those control actions.

While the user associated with second avatar 203 does not have a visible control interface illustrated in FIG. 3A, it is to be understood that a contextual indication of the deletion of the virtual object 206 may be provided to a user of the second avatar 203. Such a contextual indication provides a sensory signal that helps communicate that the virtual object 206 has been deleted. In some implementations, a contextual indication of deletion may include an animation of the explosion of the virtual object 206 or another animation indicating removal of the virtual object 206, and/or the playback of a crumbling sound, an explosion sound, or another sound indicative of a deletion. Other indications may also be appropriate, such as alternative animations, sounds or combinations thereof.

### Example User Interface

FIG. 3B is a schematic of an alternative user interface 350 with a display of user intent, in accordance with some implementations. As illustrated, the user interface 350 may include a rendered 2D view of a 3D virtual environment. Aspects of a 2D view are discussed further with respect to FIG. 2. The rendered 2D view may be a 3D view if viewed through 3D goggles or another 3D viewing interface, in some implementations. Aspects of a 3D view are discussed further with respect to FIG. 2. It is noted that controls may also be implemented by movements, motions, and/or gestures, discussed further with respect to FIG. 3A.

As shown in FIG. 3B, a first avatar 352 is rendered at a different relative size to a second avatar 353. Furthermore, first avatar 352 and second avatar 353 include respective representations of left and right controllers and/or hands illustrated. For example, a left hand/controller 354 and a right hand/controller 355 are associated with first avatar 352 and rendered at a size relative to the first avatar 352 such that other users may intuitively understand that first avatar 352 is interacting with virtual object 356 which is also of a relative size associated with the larger first avatar 352. In this manner, any user viewing the interface 350 may understand that the first avatar 352 is manipulating the virtual object 356.

As further shown in FIG. 3B, left hand/controller 359 and right hand/controller 358 are rendered at a size relative to (and are associated with) the smaller rendered second avatar 353. As such, any user viewing the interface 350 may intuitively understand that while the larger first avatar 352 is actively interacting with virtual object 356, the second avatar 353 is actively interacting with virtual object 357.

It is noted that other avatars with associated size renderings may also be included without departing from the scope of this disclosure. In this manner, multiple similarly sized avatars may be rendered proximate to first avatar 352 if they are interacting with virtual object 356. Similarly, multiple similarly sized avatars may be rendered proximate to second avatar 353 if they are interacting with virtual object 357.

Although not illustrated in FIG. 3B, it is to be understood that other types of avatar renderings, including full body and high resolution renderings and/or lifelike avatar renderings may be rendered of differing sizes and/or with virtual controllers and/or appendages that display and convey a user's intent. Furthermore, multiple differently sized avatars that are associated with multiple different virtual objects of different sizes may also be applicable. Accordingly, while a particular example has been illustrated and described, the same may be varied in many ways depending upon various particular implementations.

### Object Positioning

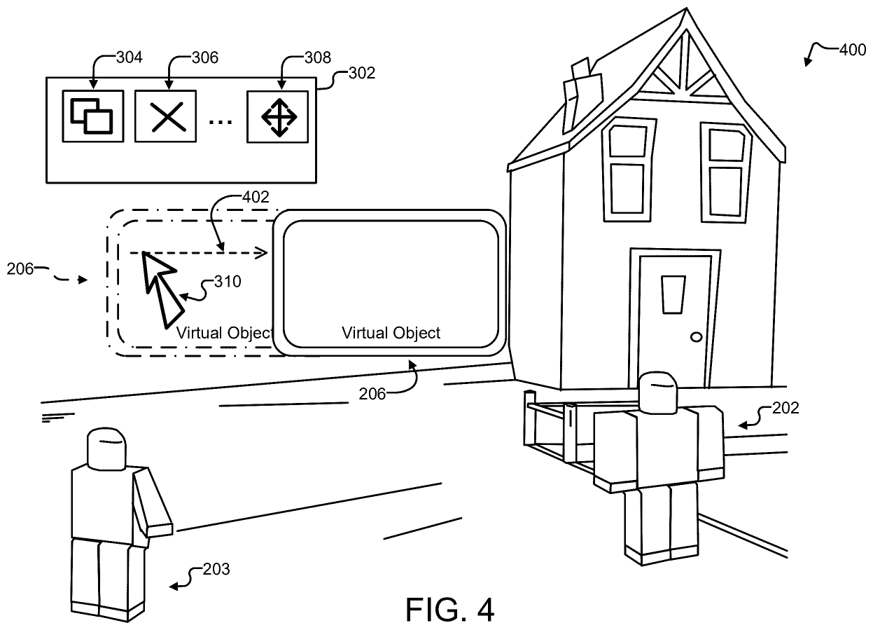

FIG. 4 is a schematic of a user interface with schematic of accessible controls for a virtual environment, in accordance with some implementations. As illustrated, the user interface 400 may include a rendered 2D view of a 3D virtual environment. Aspects of a 2D view are discussed further with respect to FIG. 2. The rendered 2D view may be a 3D view if viewed through 3D goggles or another 3D viewing interface, in some implementations. Aspects of a 3D view are discussed further with respect to FIG. 2.

As illustrated in FIG. 4, the user associated with the first avatar 202 has selected the repositioning element 308, selected the virtual object 206, and traced a line 402 (traced as a linear path using cursor 310) representing the path of motion desired for the virtual object 206. Upon inputting these control signals and further inputting a signal to implement the control signals, the virtual experience (VE) user interface (UX) component 130 may direct the platform 100 to implement a repositioning of the virtual object 206 as illustrated in FIG. 4. Accordingly, a user may use one hand, finger, or appendage to issue these commands such that a user with limited mobility or dexterity may still engage with and create virtual environments.

While the user associated with second avatar 203 does not have a visible control interface illustrated in FIG. 4, it is to be understood that a contextual indication of the movement of the virtual object 206 may be provided. In this example, a contextual indication of movement may include an animation of the repositioning of the virtual object 206 illustrating motion of the virtual object 206 and/or the playback of a scraping sound or another sound associated with a motion of the virtual object 206. Other indications may also be provided as appropriate to provide a contextual indication of the movement of the virtual object 206.

### Object Copying-Pasting

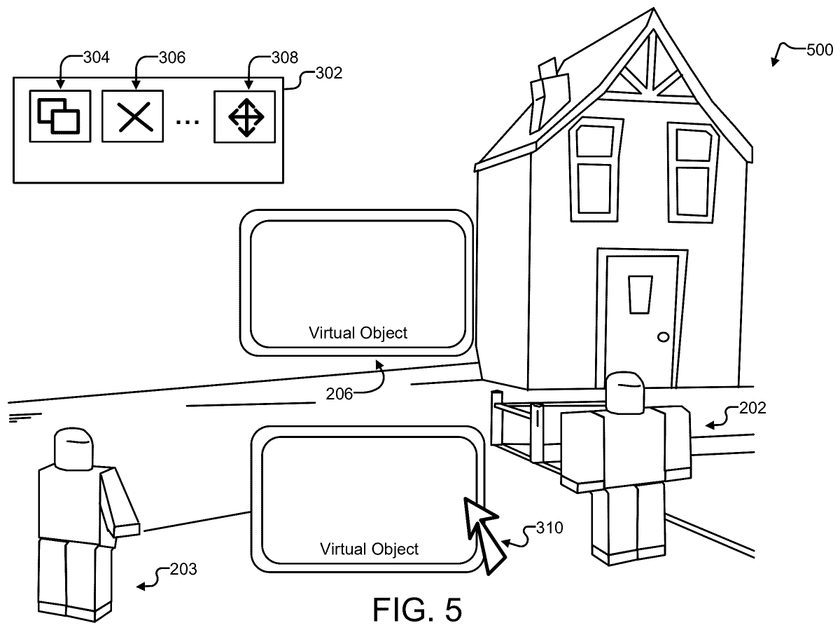

FIG. 5 is a schematic of a user interface with accessible controls for a virtual environment, in accordance with some implementations. As illustrated, the user interface 500 may include a rendered 2D view of a 3D virtual environment. Aspects of a 2D view are discussed further with respect to FIG. 2. The rendered 2D view may also include a 3D view if viewed through 3D goggles or another 3D viewing interface, in some implementations. Aspects of a 3D view are discussed further with respect to FIG. 2.

As illustrated, the user associated with the first avatar 202 has selected the copy-paste element 304, selected the virtual object 206, and selected a location for the pasting of the virtual object 206 using the cursor 310. Upon inputting these control signals and further inputting a signal to implement the control signals, the VE UX component 130 may direct the platform 100 to implement a copy-paste action of the virtual object 206 as illustrated in FIG. 5. Accordingly, a user may use one hand, finger, or appendage to issue these commands such that a user with limited mobility or dexterity may still engage with and create virtual environments including repetitive copy-pasting of elements.

While the user associated with second avatar 203 does not have a visible control interface illustrated in FIG. 5, it is to be understood that a contextual indication of the copying and pasting of the virtual object 206 may be provided. In this example, a contextual indication of copying and pasting may include an animation of the pasting of the virtual object 206 and/or the playback of a thumping sound indicative of a pasting operation or another appropriate sound. Other indications may also be provided as appropriate to provide a contextual indication of the copying and pasting of the virtual object 206.

While these example control inputs have been illustrated with respect to a limited number of particular examples, it is to be readily understood that any number of control inputs may be implemented to allow accessible computer-user interactions and the creation of virtual environments, virtual experiences, virtual objects, avatar customizations, and others.

For example, creation of new structures and/or surfaces and/or meshes may be effectuated by allowing a user associated with a given avatar to select different vertices and implement a control type to auto-populate the vertices based on other selections such as textures and pictures.

For example, users and control interfaces 302 may be displayed for multiple (or all) users to view. In this example, a user associated with second avatar 203 may view highlighted or selected portions of the control interface 302 and readily ascertain the intent of the user associated with the first avatar 202.

For example, in some implementations, a relative size and/or proportion of an avatar may be changed to represent a level of detail or graphics rendering detail that the user associated with the avatar is currently using on the user's client device. In such implementations, a user viewing at a much higher resolution may be visually rendered to be much larger than other users viewing at a lower resolution. The users operating at a lower resolution may be rendered to be smaller, visually, than the user viewing at the higher resolution. In this manner, other users may intuitively ascertain a level of detail at which the other user is working within.

For example, in some implementations, sounds and sound effects may be played back in spatial audio such that a user can readily understand context based on predefined sounds that represent user activities (e.g., explosion sounds can denote a deletion, thump sounds can denote an insertion or a creation of new objects, scraping sounds can denote moving objects, etc.).

For example, other control interfaces including tool palettes may be rendered as being hovered over a cursor (or another representation of a controller on-screen) and such control interfaces may allow for various options of single-handed control. In this manner, a tool palette or control interface may be rendered in proximity to a user's on-screen cursor such that the user may not have to provide extensive or otherwise difficult to provide inputs to move the cursor far away on-screen to access the control interfaces or tool palettes.

Other variations including combinations of the above examples, may also be applicable.

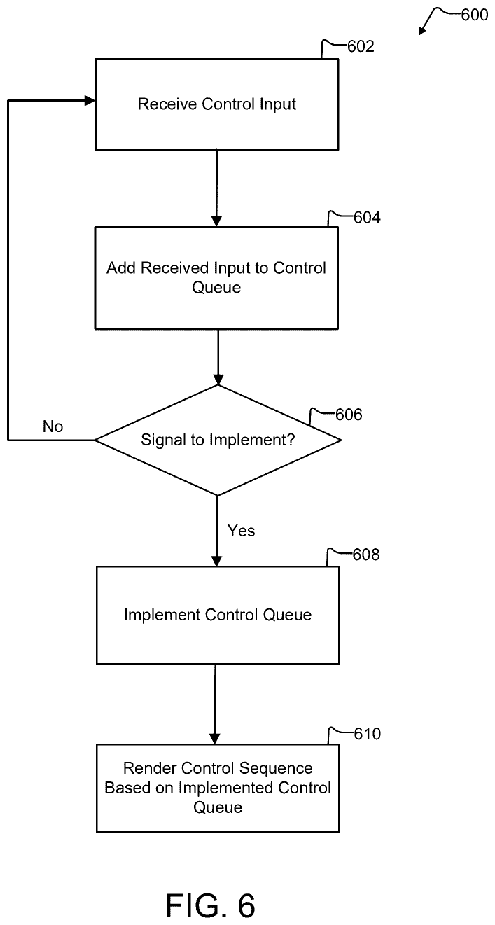

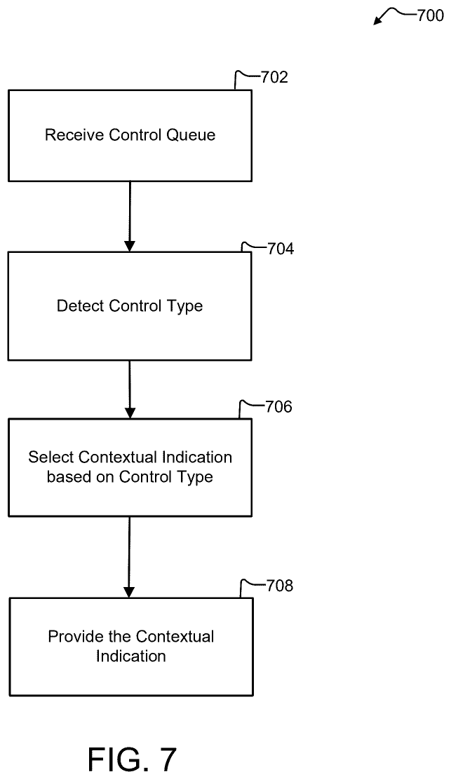

Hereinafter, methods of providing accessible controls for a virtual environment are described in detail with reference to FIGS. 6-7.

### Example Method of Accessible Control

FIG. 6 is a flowchart of an example method of accessible control over a virtual environment, in accordance with some implementations.

In some implementations, method 600 can be implemented, for example, on a server 102 described with reference to FIG. 1 and FIG. 2. In some implementations, some or all of the method 600 can be implemented on one or more client devices 110 as shown in FIG. 1, on one or more developer devices (not illustrated), or on one or more server device(s) 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 600. In some examples, a first device is described as performing blocks of method 600. Some implementations can have one or more blocks of method 600 performed by one or more other devices (e.g., other client devices or server devices) that can send results or data to the first device.

In some implementations, the method 600, or portions of the method, can be initiated automatically by a system. In some implementations, the implementing system is a first device. For example, the method (or portions thereof) can be periodically performed, or performed based on one or more particular events or conditions, e.g., a time since last control input exceeding a threshold, a number of control inputs exceeding a threshold, a predetermined time period having expired since the last performance of method 600 for a particular user, and/or one or more other conditions occurring which can be specified in settings read by the method.

Method 600 may begin at block 602. At block 602, a control input may be received (e.g., from a user associated with a first avatar). For example, a control input may include a cursor movement, a button press, a joystick movement, a cursor selection, and others (e.g., provided by a user with a single hand, with a voice input, etc.). The control input may not be immediately implemented and instead may be stored for future implementation. Block 602 may be followed by block 604.

At block 604, control input(s) received at block 602 may be added to a control queue. The control queue may be a linear sequence of operations to be performed upon a signal issued by a user. For example, the operations in a control queue may be associated with a certain order in which the operations are to be performed. In this manner, any number of control inputs or control gestures may be stored in a control queue to be performed according to a desired outcome, as if the operations in the control queue were performed using two or more hands to interact with a computer. Hence, a user lacking the ability to provide options with two or more hands, fingers, or appendages may be able to structure a control queue including operations that substitute for this ability.

The control inputs may also be translated into more complex operations instead of a control queue. For example, a selection input and a drag gesture may be stored as a single control input to resize a selected virtual object by a particular percentage based on the relative size of the drag gesture. In this example, block 604 may represent a translation of the received control inputs into a control sequence similar to a control queue, but not necessarily containing all of the received control inputs. In other implementations, gestures may be interpreted as control inputs to be implemented immediately upon cessation of the gestures, for example, by immediately implementing gestures upon receipt. Other variations may also be applicable. Block 604 may be followed by block 606.

At block 606, it is determined whether a signal to execute the control queue has been received. If no signal to execute the control queue has been received, block 606 is followed by block 602 to receive more control input(s). Else, if the signal to execute the control queue has been received, block 606 is followed by block 608.

It is noted that the signal to execute the control queue may be implemented in many ways. For example, the signal to execute the control queue may include the release of a button, the input of a gesture, the pressing of a button, and other signals. Accordingly, a user using one hand, finger, or appendage may input gestures and depress or release buttons to signal an intent to implement a sequence of control inputs from the control queue.

In some implementations, the signal to execute the control queue can also include a combination of two or more different button/key presses to effectuate implementation of a sequence of control items (e.g., depressing two buttons simultaneously on one or more controllers or on a keyboard may signal the desire to implement the sequence). Other forms of signals are also applicable.

At block 608, the control queue created at blocks 602-606 may be executed. For example, if the control queue includes a sequence of operations used to resize an object (e.g., a virtual object), the network environment 100 may direct individual components to resize the object, and so on. Block 608 may be followed by block 610.

At block 610, the control sequence executed at block 608 may be rendered for display and/or a contextual indicator may be issued. For example, the VE UX 130 may direct the platform 100 to render an animation of an object growing or decreasing in size as a rendering of one example control sequence. Similarly, the VE UX 130 may playback a sound or a combination of sounds that represent contextual clues to the resizing of the object (e.g., crescendo sounds for an increase in size, diminuendo sounds for a decrease in size, or other sounds). The rendering may be performed in combination with the animation and/or audio playback, in some implementations.

In some implementations, each action in the queue may be executed at 608, corresponding rendering may be performed at 610, and then the next action may be executed at 608, until all actions are executed. In other words, blocks 608-610 may be repeated for each input in the control queue.

In some implementations, the rendering and the audio playback may be performed independently or individually, based on user preferences. For example, implementations in which a user has limited hearing or muted speakers may prefer only animations to be provided as contextual indicators. For example, implementations in which a user has limited sight, a visual-processing disability. or limited access to a display screen may prefer sounds to be played back as contextual indicators. In other implementations, users may prefer both visual and audio contextual indicators to be performed together as contextual indicators.

Other variations may also be applicable based on user preferences. For example, in some implementations, certain control inputs may be provided with only visual contextual indicators, other control inputs may be provided with only audio contextual indicators, and still other control inputs may be provided with both visual and audio contextual indicators, according to user preferences.

Blocks 602-610 can be performed (or repeated) in a different order than described above and/or one or more blocks can be omitted. For example, blocks 602-606 may be performed repeatedly as avatars engage with the different control elements. Method 600 can be performed on a server (e.g., 102) and/or a client device (e.g., 110). Furthermore, portions of the method 600 may be combined and performed in sequence or in parallel, according to any desired implementation.

### Example Method of Contextual Indication

FIG. 7 is a flowchart of an example method of contextual indication, in accordance with some implementations.

In some implementations, method 700 can be implemented, for example, on a server 102 described with reference to FIG. 1. In some implementations, some or all of the method 700 can be implemented on one or more client devices 110 as shown in FIG. 1, on one or more developer devices (not illustrated), or on one or more server device(s) 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 700. In some examples, a first device is described as performing blocks of method 700. Some implementations can have one or more blocks of method 700 performed by one or more other devices (e.g., other client devices or server devices) that can send results or data to the first device.

In some implementations, the method 700, or portions of the method, can be initiated automatically by a system. In some implementations, the implementing system is a first device. For example, the method (or portions thereof) can be periodically performed, or performed based on one or more particular events or conditions, e.g., a time since last control input exceeding a threshold, a number of control inputs exceeding a threshold, a predetermined time period having expired since the last performance of method 700 for a particular user, and/or one or more other conditions occurring which can be specified in settings read by the method.

Method 700 may begin at block 702. At block 702, a control queue is received. For example, the control queue may be received in parallel to performance of the method 600, in some implementations. The control queue may also be assembled independently from the entire method 600. The control queue may include a sequence of control operations to be performed or otherwise indicate a type of control action (e.g., resize, reposition, delete, copy-and-paste, etc.) to be performed. Block 702 may be followed by block 704.

At block 704, a control type is detected based on the received control queue. For example, a control type may include a type of action or activity, such as resizing of an object, deletion of an object, movement of an object, copy-and-paste of an object, and so on. Block 704 may be followed by block 706.

At block 706, one or more contextual indicators may be selected based upon the control type and user preferences. For example, audio contextual indicators, visual contextual indicators, and combinations of such indicators may be selected based upon the control type and user preferences. Audio contextual indicators may include sounds representing the control type. Visual contextual indicators may include animations or presentations of visual data representing the control type.

Many different forms of contextual indicators may be applicable. For example, audio indicators may include sounds representing motion (associated with repositioning an object), destruction (associated with deleting an object), building (associated with copy-and-pasting an object), augmenting or decreasing (associated with resizing an object), and others. In some implementations, complex sounds or sequences of sounds may be arranged to represent more complex actions (e.g., a scraping sound followed by an explosion sound for a repositioning of a new object in place of a prior object, and the subsequent deletion of the prior virtual object).

Haptic feedback or vibrations may also be provided as contextual indicators. Such haptic feedback or vibrations may be provided using actuators, such as eccentric rotating mass (ERM) actuators, linear resonant actuators (LRA), or piezoelectric actuators, as non-limiting examples.

In these examples, the haptic feedback may be altered to different forms of feedback representative of different control types. For example, a long frequency vibration may represent dragging a large object across a floor to reposition it. For example, a short frequency vibration of fast duration may represent an undo-action control type. Other variations and types of haptic feedback may also be applicable. A user may also provide user preferences that associate haptic feedback signals having different characteristics with different control types. For example, a single haptic vibration may indicate one control type, while two successive haptic vibrations may indicate another control type.

Visual indicators may include animations or renderings of different visual information to represent control types. In some implementations, an avatar's relative size may be increased to depict context that the avatar is resizing objects to a larger size or to depict repositioning of larger objects. In some implementations, a control interface for an avatar may show highlighted selections of control types that are being performed that can be made visible to other avatars. Such highlighting may help other avatars identify the control types that are being performed. Other variations may also be applicable. Block 706 may be followed by block 708.

At block 708, the contextual indication is provided. It is noted that the contextual indication may be provided to other avatars within the provided user interface that are not performing the activity. In this manner, group interaction and creation of virtual experiences for many different users is possible, with contextual indication(s) providing important contextual clues to the other users of intent and direction that another user may be implementing.

Accordingly, users can intuitively and easily understand the actions of another user, without having to use a hand or another form of control input to type out chats, speak to ask questions, view the actions (if visually impaired), hear the actions (if hearing impaired), or take other actions. Thus, users associated with other avatars may have access to information about control inputs in a control queue built by a user of another avatar that would not otherwise be available to the users.

Blocks 702-708 can be performed (or repeated) in a different order than described above and/or one or more blocks can be omitted. Method 700 can be performed on a server (e.g., 102) and/or a client device (e.g., 110). Furthermore, portions of the method 700 may be combined and performed in sequence or in parallel, according to any desired implementation.

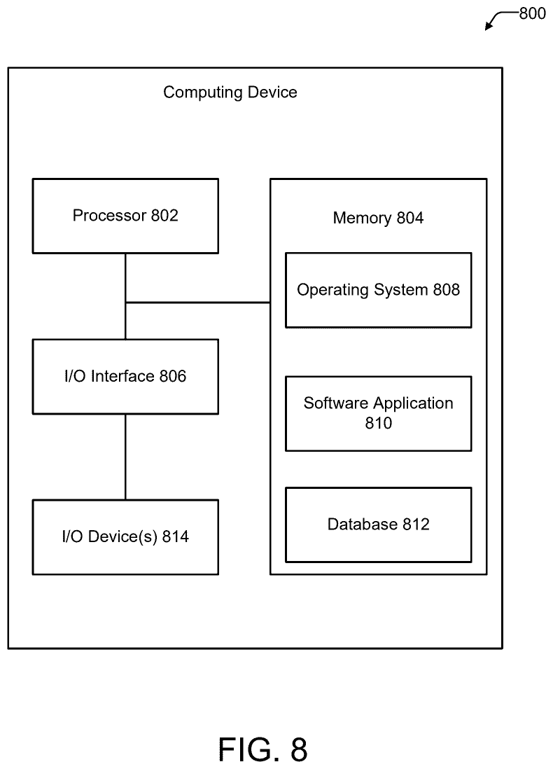

Hereinafter, a more detailed description of various computing devices that may be used to implement different devices and/or components illustrated in FIG. 1 is provided with reference to FIG. 8.

### Computing Devices

FIG. 8 is a block diagram of an example computing device 800 which may be used to implement one or more features described herein, in accordance with some implementations. In one example, device 800 may be used to implement a computer device, (e.g., 102, 110 of FIG. 1), and perform appropriate operations as described herein. Computing device 800 can be any suitable computer system, server, or other electronic or hardware device. For example, the computing device 800 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 800 includes a processor 802, a memory 804, input/output (I/O) interface 806, and audio/video input/output devices 814 (e.g., display screen, touchscreen, display goggles or glasses, audio speakers, headphones, microphone, etc.).

Processor 802 can be one or more processors and/or processing circuits to execute program code and control basic operations of the device 800. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 804 is typically provided in device 800 for access by the processor 802, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 802 and/or integrated therewith. Memory 804 can store software operating on the computing device 800 by the processor 802, including an operating system 808, software application 810 and associated database 812. In some implementations, the applications 810 can include instructions that enable processor 802 to perform the functions described herein, e.g., some or all of the methods of FIG. 6 and FIG. 7. Software application 810 may include some or all of the functionality required to present accessible 3D controls and contextual indicators. In some implementations, one or more portions of software application 810 may be implemented in dedicated hardware such as an application-specific integrated circuit (ASIC), a programmable logic device (PLD), a field-programmable gate array (FPGA), a machine learning processor, etc. In some implementations, one or more portions of software application 810 may be implemented in general purpose processors, such as a central processing unit (CPU) or a graphics processing unit (GPU). In various implementations, suitable combinations of dedicated and/or general purpose processing hardware may be used to implement software application 810.

For example, software application 810 stored in memory 804 can include instructions for displaying/presenting accessible 3D controls and contextual indicators, and/or other functionality or software such as the VE UX component 130, VE Engine 104, and/or VE Application 112. Any of software in memory 804 can alternatively be stored on any other suitable storage location or computer-readable medium. In addition, memory 804 (and/or other connected storage device(s)) can store instructions and data used in the features described herein. Memory 804 and any other type of storage (magnetic disk, optical disk, magnetic tape, or other tangible media) can be considered “storage” or “storage devices.”

I/O interface 806 can provide functions to enable interfacing the computing device 800 with other systems and devices. For example, network communication devices, storage devices (e.g., memory and/or data store 108), and input/output devices can communicate via I/O interface 806. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 8 shows one block for each of processor 802, memory 804, I/O interface 806, software blocks 808 and 810, and database 812. These blocks may represent one or more processors or processing circuitries, operating systems, memories, I/O interfaces, applications, and/or software modules. In other implementations, device 800 may not have all of the components shown and/or may have other elements including other types of elements instead of, or in addition to, those shown herein. While the online server 102 are described as performing operations as described in some implementations herein, any suitable component or combination of components of online server 102, or similar system, or any suitable processor or processors associated with such a system, may perform the operations described.

A user device can also implement and/or be used with features described herein. Example user devices can be computer devices including some similar components as the device 800, e.g., processor(s) 802, memory 804, and I/O interface 806. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 814, for example, can be connected to (or included in) the device 800 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., method 600 and/or method 700) can be implemented by computer program instructions or code, which can be executed on a computer. For example, the code can be implemented by one or more digital processors (e.g., microprocessors or other processing circuitry), and can be stored on a computer program product including a non-transitory computer-readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

In situations in which certain implementations discussed herein may obtain or use user data (e.g., user demographics, user behavioral data, user contextual data, etc.) users are provided with options to control whether and how such information is collected, stored, or used. That is, the implementations discussed herein collect, store and/or use user information upon receiving explicit user authorization and in compliance with applicable regulations.

Users are provided with control over whether programs or features collect user information about that particular user or other users relevant to the program or feature. Each user for which information is to be collected is presented with options (e.g., via a user interface) to allow the user to exert control over the information collection relevant to that user, to provide permission or authorization as to whether the information is collected and as to which portions of the information are to be collected. In addition, certain data may be modified in one or more ways before storage or use, such that personally identifiable information is removed. As one example, a user's identity may be modified (e.g., by substitution using a pseudonym, numeric value, etc.) so that no personally identifiable information can be determined. In another example, a user's geographic location may be generalized to a larger region (e.g., city, zip code, state, country, etc.).

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to provide accessible control in a virtual experience of a virtual environment, the method comprising:
receiving control inputs from an input device, the control inputs comprising a selection of a portion of a user interface of the virtual experience, tracing of a path in the user interface, or a combination thereof;
assembling a control queue based on the received control inputs;
implementing the control queue by directing a virtual experience engine to perform control actions corresponding to the received control inputs in the control queue;
rendering results of the implementation of the control queue by updating the user interface; and
providing one or more contextual indicators of the results of the implementation of the control queue in the user interface.

2. The computer-implemented method of claim 1, wherein the received control inputs are provided by a user operating the input device via a cursor movement, a button press, a joystick movement, a cursor selection, a hardware user interface element input signal, or any combination thereof, wherein the operating the input device includes one or more actions performed using a single hand, a single finger, or a single appendage of the user.

3. The computer-implemented method of claim 1, wherein two or more distinct control inputs are assembled in the control queue as a combined control input and the combined control input is implemented as a single input.

4. The computer-implemented method of claim 1, wherein directing the virtual experience engine to implement the control queue comprises receiving user input from a user performed using a single hand, a single finger, or a single appendage of the user, wherein the input device is a hardware user interface element of a client device of the user.

5. The computer-implemented method of claim 1, further comprising:
detecting a control type of at least one of the received control inputs based on the assembled control queue; and
providing the one or more contextual indicators based upon the control type and user preferences, wherein the contextual indicators comprise audio contextual indicators, visual contextual indicators, haptic contextual indicators, or any combination thereof.

6. The computer-implemented method of claim 5, wherein the detected control type is one of a resize control type, a copy-paste control type, a deletion control type, or a repositioning control type.

7. The computer-implemented method of claim 1, wherein the received control inputs, when implemented, resize a virtual object in the virtual experience and the received control inputs comprise a first control input selecting a corner of the virtual object and a second control input indicating a linear path corresponding to a new size of the virtual object, wherein the virtual object is resized based on the first control input and the second control input.

8. The computer-implemented method of claim 1, further comprising receiving a selection of a control element, wherein the selected control element is a copy-paste control element, a deletion control element, or a repositioning control element, wherein the virtual object is modified based on the selected control element.

9. The computer-implemented method of claim 8, wherein when the selected control element is the copy-paste control element, the received control inputs further comprise a first control input selecting a virtual object in the virtual experience to be copied and pasted, a second control input indicating a location in the virtual experience for the virtual object to be copied to, and a final control input signaling the virtual experience to copy and paste the virtual object, wherein the virtual object is copied and pasted based on the first control input and the second control input.

10. The computer-implemented method of claim 8, wherein when the selected control element is the deletion control element, the received control inputs further comprise a first control input selecting a virtual object in the virtual experience to be deleted, and a final control input signaling the virtual experience to delete the virtual object, wherein the virtual object is deleted based on the first control input.

11. The computer-implemented method of claim 8, wherein when the selected control element is the repositioning control element, the received control inputs further comprise a first control input selecting a virtual object to be repositioned in the virtual experience, a second control input indicating a linear path of motion for the virtual object, and a final control input signaling the virtual experience to reposition the virtual object based on the first control input and the second control input, wherein the virtual object is repositioned based on the first control input and the second control input.

12. A non-transitory computer-readable medium with instructions stored thereon that, responsive to execution by a processing device, causes the processing device to perform operations comprising:
receiving control inputs from an input device, the control inputs comprising a selection of a portion of a user interface of a virtual experience of a virtual environment, tracing of a path in the user interface, or a combination thereof;
assembling a control queue based on the received control inputs;
implementing the control queue by directing a virtual experience engine to perform control actions corresponding to the received control inputs in the control queue;
rendering results of the implementation of the control queue by updating the user interface; and
providing one or more contextual indicators of the results of the implementation of the control queue in the user interface.

13. The non-transitory computer-readable medium of claim 12, wherein two or more distinct control inputs are assembled in the control queue as a combined control input and the combined control input is implemented as a single input.

14. The non-transitory computer-readable medium of claim 12, the operations further comprising:
detecting a control type of at least one of the received control inputs based on the assembled control queue; and
providing the one or more contextual indicators based upon the control type and user preferences, wherein the contextual indicators comprise audio contextual indicators, visual contextual indicators, haptic contextual indicators, or any combination thereof.

15. The non-transitory computer-readable medium of claim 12, wherein the received control inputs, when implemented, resize a virtual object in the virtual experience and the received control inputs comprise a first control input selecting a corner of the virtual object and a second control input indicating a linear path corresponding to a new size of the virtual object, wherein the virtual object is resized based on the first control input and the second control input.

16. The non-transitory computer-readable medium of claim 12, the operations further comprising receiving a selection of a control element, wherein the selected control element is a copy-paste control element, a deletion control element, or a repositioning control element.

17. A system comprising:
a memory with instructions stored thereon; and
a processing device, coupled to the memory, the processing device configured to access the memory and execute the instructions, wherein the instructions cause the processing device to perform operations comprising:
receiving control inputs from an input device, the control inputs comprising a selection of a portion of a user interface of a virtual experience of a virtual environment, tracing of a path in the user interface, or a combination thereof;
assembling a control queue based on the received control inputs;
implementing the control queue by directing a virtual experience engine to perform control actions corresponding to the received control inputs in the control queue;
rendering results of the implementation of the control queue by updating the user interface; and
providing one or more contextual indicators of the results of the implementation of the control queue in the user interface.

18. The system of claim 17, wherein two or more distinct control inputs are assembled in the control queue as a combined control input and the combined control input is implemented as a single input.

19. The system of claim 17, the operations further comprising:
detecting a control type of at least one of the received control inputs based on the assembled control queue; and
providing the one or more contextual indicators based upon the control type and user preferences, wherein the contextual indicators comprise audio contextual indicators, visual contextual indicators, haptic contextual indicators, or any combination thereof.

20. The system of claim 17, the operations further comprising receiving a selection of a control element, wherein the selected control element is a copy-paste control element, a deletion control element, or a repositioning control element.
